(19) United States
(12) Patent Application Publication
(10) Pub. No.: US 2025/0247268 A1
(43) Pub. Date: Jul. 31, 2025

(54) INFORMATION OUTPUT METHOD, INFORMATION PROCESSING DEVICE, AND RECORDING MEDIUM

(71) Applicant: Panasonic Intellectual Property Corporation of America, Torrance, CA (US)

(72) Inventors: Masataka UEMURA, Nara (JP); Atsushi NISHIMURA, Osaka (JP); Hirokazu KITO, Osaka (JP)

(73) Assignee: Panasonic Intellectual Property Corporation of America, Torrance, CA (US)

(21) Appl. No.: 19/183,154

(22) Filed: Apr. 18, 2025

Related U.S. Application Data
(63) Continuation of application No. PCT/JP2023/037540, filed on Oct. 17, 2023.

(30) Foreign Application Priority Data
Nov. 9, 2022 (JP) 2022-179794

(51) Int. Cl. H04L 12/28

(52) U.S. Cl. CPC H04L 12/2829; H04L 12/2814

(57) ABSTRACT

An information processing device acquires operation information of a plurality of devices installed in a space. The information processing device maps operation information of a device installed in a shared space used by a plurality of users to the plurality of users. The information processing device maps operation information of a device installed in a specific space used by a specific user to the specific user. The information processing device outputs at least one of the operation information mapped to the plurality of users and the operation information mapped to the specific user.

### CROSS-REFERENCE TO RELATED APPLICATION

This application is based upon and claims the benefit of priority from the prior Japanese Patent Application No. 2022-179794, filed on Nov. 9, 2022 and the prior PCT Application No. PCT/JP2023/037540, filed on Oct. 17, 2023, the entire contents of which are incorporated herein by reference.

### BACKGROUND

### 1. Technical Field

The present disclosure relates to data processing technology and particularly to an information output method, an information processing device, and a recording medium.

### 2. Description of the Related Art

The following Patent Document 1 discloses a technology for calculating an evaluation value representing the likelihood of a specific action made by a user occurring in each of a plurality of time zones based on action history data indicating the history of the date and time of occurrence of specific actions made by the user, and generating a profile representing the tendency of time zones in which the specific action made by the user occurs.

[Patent Document 1] Japanese Patent Application Publication No. 2015-87957

In a situation where various devices (e.g., home appliances, home equipment, etc.) are being connected to a network, it is conceivable to collect operation information of devices used by users and propose services to the users based on the collected operation information. The services to be proposed to the users may vary depending on the attributes of the operation information of the devices (e.g., whether the information reflects the intentions of all users or specific users). Therefore, there is a need to classify operation information of devices with high accuracy.

### SUMMARY

The present invention addresses the aforementioned issue, and a general purpose thereof is to provide a technology for supporting accurate classification of operation information of devices.

An information output method according to one embodiment of the present disclosure includes: acquiring operation information of a device installed in a space; using information linking the operation information of the device with the space in which the device is provided so as to: map operation information of a device installed in a shared space used by a plurality of users to the plurality of users; and map operation information of a device installed in a specific space used by a specific user to the specific user; and outputting at least one of the operation information mapped to the plurality of users and the operation information mapped to the specific user.

Another embodiment of the present disclosure relates to an information output method. This method includes: using operation information of a device installed in a shared space used by a plurality of users so as to select a service for the plurality of users; using operation information of a device installed in a specific space used by a specific user so as to select a service for the specific user; and outputting at least one of information on the service for the plurality of users and information on the service for the specific user.

Yet another embodiment of the present disclosure relates to an information processing device. This device includes: an acquisition unit that acquires operation information of a device installed in a space; a linking unit that uses information linking the operation information of the device with the space in which the device is provided so as to: map operation information of a device installed in a shared space used by a plurality of users to the plurality of users; and map operation information of a device installed in a specific space used by a specific user to the specific user; and an output unit that outputs at least one of the operation information mapped to the plurality of users and the operation information mapped to the specific user.

Yet another embodiment of the present disclosure invention also relates to an information processing device. This device includes: a selection unit that uses operation information of a device installed in a shared space used by a plurality of users so as to select a service for the plurality of users, and that uses operation information of a device installed in a specific space used by a specific user so as to select a service for the specific user; and an output unit that outputs at least one of information on the service for the plurality of users and information on the service for the specific user.

Optional combinations of the aforementioned constituting elements, and implementations of the disclosure in the form of systems, computer programs, recording mediums encoded with computer programs, etc., may also be practiced as additional modes of the present disclosure.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram showing the configuration of an information processing system according to the first embodiment;

FIG. 2 is a block diagram showing functional blocks of an information processing device;

FIG. 3 is a diagram showing examples of device and location rules;

FIG. 4 is a diagram showing examples of location and attribute rules;

FIG. 5 is a flowchart showing the operation of an information processing device according to the first embodiment;

FIG. 6 is a diagram showing examples of operation information for environmental control devices and seasonal devices;

FIG. 7 is a diagram showing examples of operation information of cooking devices;

FIG. 8 is a diagram showing examples of post-processing operation information;

FIG. 9 is a flowchart showing the operation of an information processing device according to the first embodiment;

FIG. 10 is a diagram showing examples of service decision rules;

FIG. 11 is a diagram showing other examples of service decision rules;

FIG. 12 is a block diagram showing functional blocks of an information processing device according to the second embodiment;

FIG. 13 is a diagram showing examples of user operation and hierarchy rules; and

FIG. 14 is a diagram showing examples of post-processing operation information.

### DETAILED DESCRIPTION OF THE EMBODIMENTS

The invention will now be described by reference to the preferred embodiments. This does not intend to limit the scope of the present invention, but to exemplify the invention.

The device or the entity that executes the method according to the present disclosure is provided with a computer. By causing the computer to run a program, the function of the device or the entity that executes the method according to the disclosure is realized. The computer includes a processor that operates in accordance with the program as a main hardware feature. The disclosure is non-limiting as to the type of the processor so long as the function is realized by running the program. The processor is comprised of one or a plurality of electronic circuits including a semiconductor integrated circuit (IC) or a large-scale integration (LSI). Although the term IC or LSI is used here, the name changes depending on the degree of integration, and those that are referred to as system LSI, very large scale integration (VLSI), or ultra large scale integration (ULSI) may be used. Field programmable gate arrays (FPGAs) programmed after the manufacturing of an LSI, or reconfigurable logic devices capable of reconfiguring junction relationships within the LSI or setting up circuit partitions inside the LSI can be also used for the same purpose. The plurality of electronic circuits may be integrated in one chip or provided in a plurality of chips. The plurality of chips may be aggregated in one device or provided in a plurality of devices. The program may be recorded in a non-transitory recording medium such as a computer-readable read only memory (ROM), optical disk, and hard disk drive or may be recorded in a temporary storage medium such as a computer-readable random access memory (RAM). The program may be stored in a recording medium in advance or supplied to a recording medium or a memory medium via a wide area communication network including the Internet.

The first and second embodiments of the present disclosure propose a technology for analyzing operation information of devices and proposing services to users that are compatible with the operation information.

### First Embodiment

The information processing system according to the first embodiment analyzes the operation information of multiple devices installed in an environment having multiple spaces in accordance with the installation position of each device. More specifically, depending on the type of space in which each device is installed, the information processing system according to the first embodiment distinguishes whether the operation information of each device is information on an operation representing the intention of a specific user or information on an operation representing the intention of all users in the environment in which the multiple devices are installed. Then, services based on the result of the distinguishment are proposed to the user.

For example, a house is considered as an environment having multiple spaces. A living room of a house is a common space used by all or many of multiple users living in the house. Therefore, when a specific user operates a device installed in the living room, the specific user is considered to be likely to operate the device in consideration of other users. On the other hand, an individual room used by a specific user in a house is basically a non-shared space (also called a specific space) that is not used by other users. Therefore, when the specific user operates a device installed in that individual room, it is considered unlikely that the specific user operates the device in consideration of other users.

Therefore, an information processing system 10 according to the first embodiment classifies (handles) operation information of a device installed in a living room as reflecting the intention of users who are not operating the device as well as a user who has operated the device. The information processing system 10 according to the first embodiment links information on classified data attributes with the operation information of the device. For example, operation information of a device can be generated while taking into consideration a user's environment for a living space such as a single living space where a family of multiple members are living together. Moreover, by using such processed device operation information, it becomes easier to provide services that reflect the intentions of the user.

For example, in a family of four, a living room in a house is often used as a shared space for all family members. In such a living room, situations such as parents and children relaxing together while watching TV are expected. Therefore, it is highly likely that the operation of the device installed in the living room is set in consideration of the entire family members instead of being targeted at a specific user. For example, even in a situation where parents who are sensitive to the cold are in charge of operating the device, the air conditioner temperature setting may be assumed to be lower than that when the air conditioner is used by the parents alone in order to accommodate their children who are sensitive to the heat. In the information processing system 10 according to the second embodiment, by handling operation information of a user of a given device in a shared space (common space) as household data in such a scene, it is possible to provide services suitable for the family based on the operation status of the device.

In the first embodiment, an environment to be analyzed in which a device is installed is a house in which multiple users (a user A, a user B, and a user C) constituting a family reside; however, the environment and usage scenes to which the technology according to the present disclosure is applicable are not limited to houses or families. The environment may be any area or building where the users of each space can be identified, for example, an office or a commercial facility. The office may be a conference room used by multiple users, or an office used by individual users with an adjacent executive room. The usage scene may be a scene in which multiple users share a building with multiple spaces. The multiple spaces may be spaces that are independent of one another by walls, partitions, doors, etc. For example, the spaces correspond to multiple rooms in a house.

In the first embodiment, the operation information of the device is mapped to (1) a plurality of users or (2) a specific user in the environment to be analyzed.
(1) The plurality of users may be all users present in the environment to be analyzed or two or more users as some users present in the environment to be analyzed. In the first embodiment, an explanation will be given considering that (1) the plurality of users are all the users.
(2) The specific user may be one user or two or more users, as long as the individuals to be associated are specified.

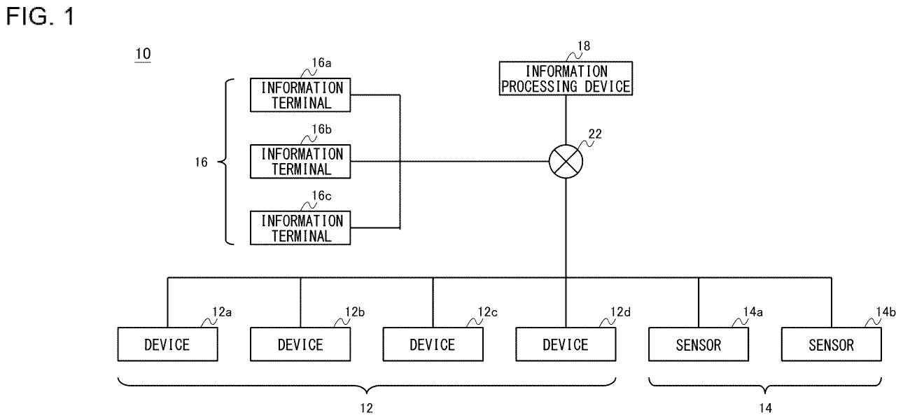

FIG. 1 shows the configuration of the information processing system 10 according to the first embodiment. The information processing system 10 includes a plurality of devices 12, a plurality of sensors 14, a plurality of information terminals 16, and an information processing device 18. Each of the devices constituting the information processing system 10 is connected via a communication network 22 including LAN, WAN, Internet, etc.

The plurality of devices 12 include devices 12a, 12b, 12c, and 12d. Each of the plurality of devices 12 includes a home appliance or equipment. Each of the plurality of devices 12 has a communication function and transmits and receives data with the information processing device 18 via the communication network 22.

The plurality of devices 12 are also classified into a plurality of categories. The plurality of categories include (1) environmental control devices and seasonal devices, (2) cooking devices, (3) audio visual (AV) devices, (4) household appliances, and (5) beauty devices and health devices.
(1) The environmental control devices and seasonal devices include air conditioners, air purifiers, and hot-water washing toilet seats.
(2) The cooking devices include microwave ovens, rice cookers, and toasters.
(3) The audio visual devices include TV sets and recorders.
(4) The household appliances include washing machines and vacuum cleaners.
(5) The beauty devices and health devices include hair dryers and facial care equipment.

In addition, each of the plurality of devices 12a to 12d includes devices that can be used (in other words, can be operated) by a plurality of users, respectively. In contrast, devices such as smartphones and tablet terminals that are mainly used by specific users and that have a function for restricting use by third parties (such as an authentication function using a password or fingerprint) may be excluded from the devices 12 to be analyzed. However, even if devices have a function of restricting users, such devices may be included in the devices 12 to be analyzed as long as the operation of the devices can benefit a plurality of users.

The plurality of sensors 14 include a sensor 14a and a sensor 14b. The plurality of sensors 14 detect various information on the operation of corresponding devices 12. Examples of various types of information acquired from each of the sensors 14 include device authentication information that can identify the device 12 and user information for identifying a user operating the device 12. At least some of the plurality of sensors 14 may be devices that identify or authenticate users using the corresponding devices 12. At least some of the plurality of sensors 14 may be incorporated into the corresponding devices 12 or may be separate from the corresponding devices 12. The plurality of sensors 14 may include at least one of a camera, a microphone, an infrared sensor, an ultrasonic sensor, a fingerprint sensor, an iris sensor, a biometric sensor, and a person detection sensor.

The plurality of information terminals 16 include an information terminal 16a, an information terminal 16b, and an information terminal 16c. The plurality of information terminals 16 are devices that are operated by users different from one another. For example, the information terminal 16a may be operated by a user A, the information terminal 16b may be operated by a user B, and the information terminal 16c may be operated by a user C. Each of the plurality of information terminals 16 may be a home appliance, equipment, computer, tablet terminal, or smartphone with a user interface (e.g., display unit).

The information processing device 18 analyzes the operation information of the plurality of devices 12 installed in a house and performs information processing for suggesting a service to the user. The information processing device 18 according to the first embodiment is a cloud server that is installed in the cloud and provides analysis of operation information and proposal of services as a cloud service. As an exemplary variation, the information processing device 18 may be an environment in which the devices 12 are installed, in other words, the information processing device 18 may be an edge server installed in an environment (e.g., a house) where the user uses the devices 12. The function of the information processing device 18 may also be embedded in an information terminal 16 operated by the user.

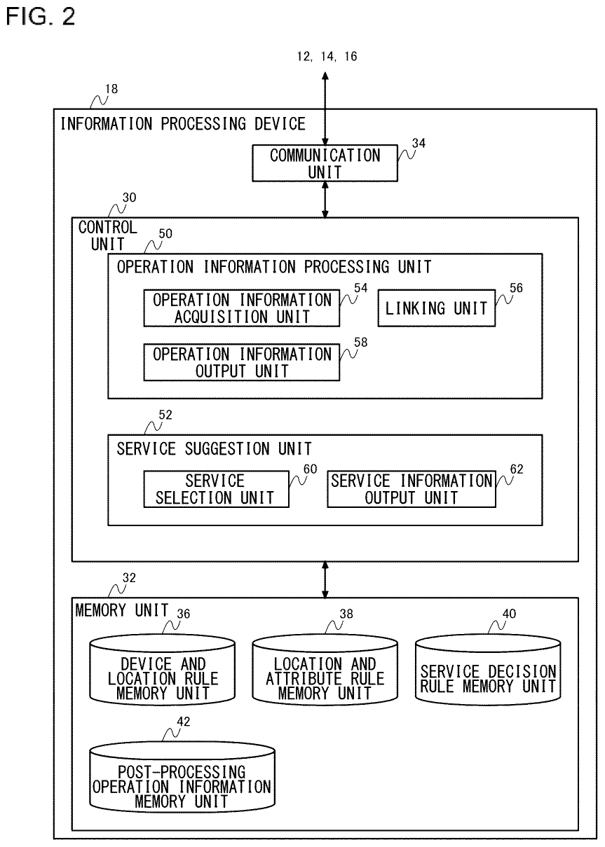

FIG. 2 is a block diagram showing functional blocks of the information processing device 18. The blocks depicted in the block diagram of the present disclosure are implemented in hardware such as elements or mechanical devices such as a CPU and a memory of a computer, and in software such as a computer program. The figure depicts functional blocks implemented by the cooperation of the hardware and the software. Therefore, it will be obvious to those skilled in the art that the functional blocks may be implemented in a variety of manners by a combination of hardware and software.

The information processing device 18 includes a control unit 30, a memory unit 32, and a communication unit 34. The control unit 30 controls the operation of the information processing device 18. The control unit 30 can also be called a data processing unit and executes various data processing and arithmetic operations. The control unit 30 may be realized by a processor (CPU, etc.) of the information processing device 18. The memory unit 32 stores data that is referenced or updated by the control unit 30. The communication unit 34 communicates with an external device according to a predetermined communication protocol. The control unit 30 transmits and receives data to and from external devices such as the devices 12, the sensors 14, and the information terminals 16 via the communication unit 34.

The memory unit 32 includes a device and location rule memory unit 36, a location and attribute rule memory unit 38, a service decision rule memory unit 40, and a post-processing operation information memory unit 42.

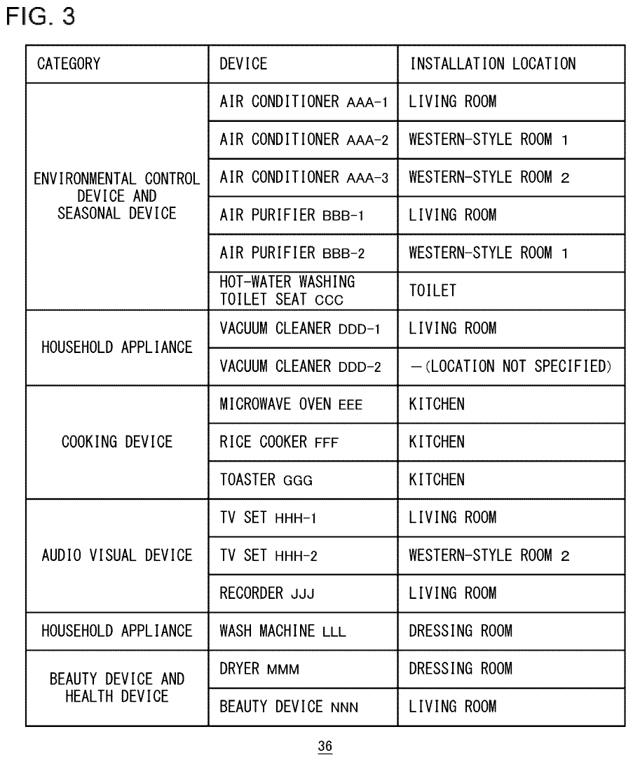

The device and location rule memory unit 36 stores data of predetermined device and location rules. FIG. 3 shows examples of the device and location rules. The device and location rules are data indicating the installation location (which can be considered as a type of space) of each of the plurality of devices 12 installed in a predetermined environment (in the first embodiment, a house). In other words, the device and location rules are data indicating correspondence rules between the devices 12 and the installation locations. The device and location rules shown in FIG. 3 include information indicating the category of each of the plurality of devices 12.

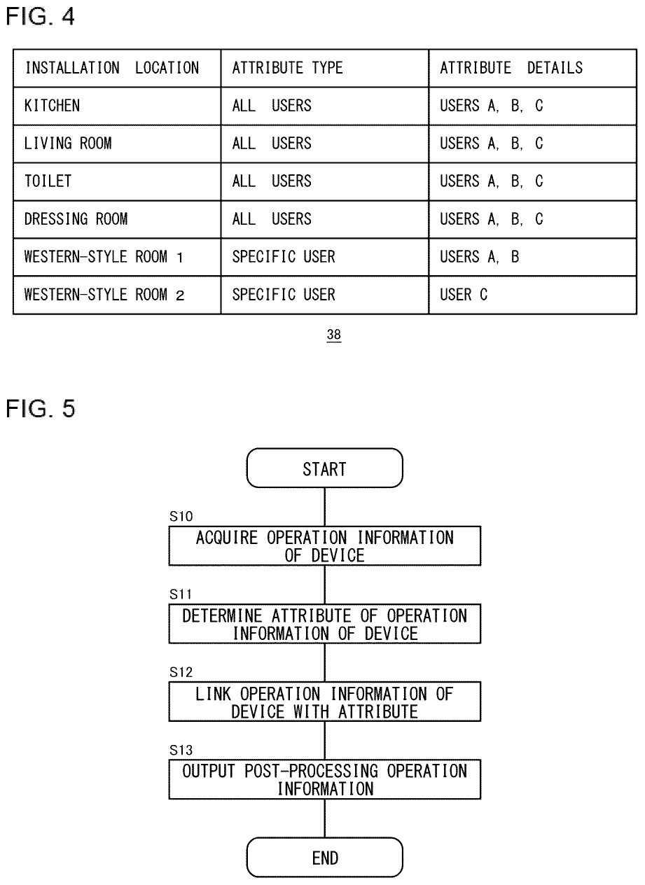

Returning to FIG. 2, the location and attribute rule memory unit 38 stores data for predetermined location and attribute rules. FIG. 4 shows examples of the location and attribute rules. The location and attribute rules are data that associate each of a plurality of spaces provided in a predetermined environment (a house in the first embodiment) with the attributes of the users who use each space. The location and attribute rules can also be considered as data that indicates correspondence rules between the installation locations of the devices 12 and the attributes to be assigned to the devices 12. The location and attribute rules shown in FIG. 4 indicate that while the kitchen is used by all users residing in the house (specifically, a user A, a user B, and a user C), a western-style room 1 is used by specific users (more specifically, the user A and the user B) and a western-style room 2 is used by a specific user (more specifically, the user C).

Regarding the western-style room 1 in FIG. 4, a case is shown where although the room is used by a plurality of users, it can be identified using the operation information of the device installed in the western-style room 1 acquired by sensor 14 that the users A and B use the room particularly frequently while the user C uses the room infrequently. In this case, the usage is recognized as the usage by a specific user. When identifying the usage status of a space based on device operation and human detection data from the sensors 14, if a single space is used by multiple users (e.g., the user A and the user B), the frequency of use of the single space by each user may be measured. For example, if the frequency of use by a specific user (e.g., the user A) exceeds that of the other user (e.g., the user B), the space may be identified as a specific space used by a particular user (e.g., the user A).

Returning to FIG. 2, the service decision rule memory unit 40 stores data of service decision rules, which are predetermined rules for determining services to be proposed to users. Examples of the service decision rules are described below. The post-processing operation information memory unit 42 stores data of post-processing operation information, which is operation information to which attributes are added to the original operation information. Examples of the post-processing operation information are described below.

The control unit 30 includes an operation information processing unit 50 and a service suggestion unit 52. The functions of these multiple functional blocks may be implemented in a computer program, and the computer program may be installed in the storage of the information processing device 18. The processor of the information processing device 18 may read this computer program into the main memory and execute the computer program so as to thereby exert the functions of the multiple functional blocks.

The operation information processing unit 50 performs a process of processing the original operation information of the devices 12, more specifically, a process of classifying the motion information by providing relevant user attributes to the original operation information of the devices 12. The operation information processing unit 50 includes an operation information acquisition unit 54, a linking unit 56, and an operation information output unit 58.

The operation information acquisition unit 54 acquires operation information of a plurality of devices 12 installed in an environment having a plurality of spaces (a house in the first embodiment). In the first embodiment, the operation information acquisition unit 54 acquires the operation information transmitted from each of the plurality of devices 12. As an exemplary variation, the operation information acquisition unit 54 may acquire the operation information of the devices 12 from the sensors 14 that monitor or detect the state of the devices 12. The information processing system 10 may also include a database that accumulates and stores the operation information of the plurality of devices 12, and the operation information acquisition unit 54 may periodically acquire the operation information of the devices 12 from the database.

The linking unit 56 classifies the operation information of the devices 12 acquired by the operation information acquisition unit 54 based on the device and location rules stored in the device and location rule memory unit 36 and the location and attribute rules stored in the location and attribute rule memory unit 38. More specifically, the linking unit 56 maps the operation information of the devices 12 installed in a space used by all users in the environment among multiple spaces in the environment to all users. Further, the linking unit 56 maps the operation information of the devices 12 installed in a space used by a specific user among multiple spaces in the environment to the specific user. All users can be considered as a plurality of users existing in the environment, and specific users can be considered as some of the plurality of users. Mapping or linking may be to store the first data and the second data that are to be mapped in a memory area in association with each other using known methods. Further, mapping or linking may be to include the key of the second data in the first data such that the second data can be referenced based on the first data.

The operation information output unit 58 outputs at least one of the operation information of the devices 12 mapped to all users and the operation information of the devices 12 mapped to specific users, which are generated by the linking unit 56. In the first embodiment, the operation information output unit 58 outputs (stores) both the operation information of the devices 12 mapped to all users and the operation information of the devices 12 mapped to specific users to the operation information memory unit 42 after processing.

The service suggestion unit 52 executes a process of suggesting services to the users based on the post-processing operation information of the devices 12. The service suggestion unit 52 includes a service selection unit 60 and a service information output unit 62.

The service selection unit 60 selects services for all users using the operation information of the devices 12 installed in the space used by all the users. In the first embodiment, the service selection unit 60 selects a service for all the users based on the operation information of the devices 12 mapped to all the users stored in the post-processing operation information memory unit 42 and the service decision rules stored in the service decision rule memory unit 40.

The service selection unit 60 also selects a service for a specific user using the operation information of the devices 12 installed in the space used by the specific user. In the first embodiment, the service selection unit 60 selects a service for a specific user based on the operation information of the devices 12 mapped to the specific user stored in the post-processing operation information memory unit 42 and the service decision rules stored in the service decision rule memory unit 40.

The service information output unit 62 outputs at least one of information on the service for all the users and information on the service for the specific user. In the first embodiment, the service information output unit 62 outputs (transmits) both information on a service for all users and information on a service for a specific user to the information terminals 16 of the users to whom the service is suggested.

The operation of the information processing system 10 according to the first embodiment with the above configuration will now be described. FIG. 5 is a flowchart showing the operation of the information processing device 18 according to the first embodiment. The figure mainly shows the operation of the operation information processing unit 50 of the information processing device 18, and specifically shows the operation of processing the operation information of a device 12 installed in a predetermined environment.

As a preliminary preparation, a user residing in a house as the predetermined environment may create device and location rules and location and attribute rules that become consistent with the condition of the house. A terminal of the user may transmit the device and location rules and location and attribute rules to the information processing device 18. The information processing device 18 may further include a rule registration unit (not shown) that receives and stores the device and location rules transmitted from the terminal of the user in the device and location rule memory unit 36 and that receives and stores the location and attribute rules transmitted from the terminal of the user in the location and attribute rule memory unit 38.

The users residing in the house (the user A, the user B, and the user C in this case) operate the devices 12 to make the devices 12 operate in daily life. The devices 12 generate operation information (which can be also referred to as an operation log), which is information on the operation of the devices based on the user operation, and transmits the operation information to the information processing device 18. The devices 12 may generate operation information including information detected by the sensors 14 (e.g., information on the operating user). The operation information acquisition unit 54 of the information processing device 18 acquires the operation information transmitted from the device 12 (S10).

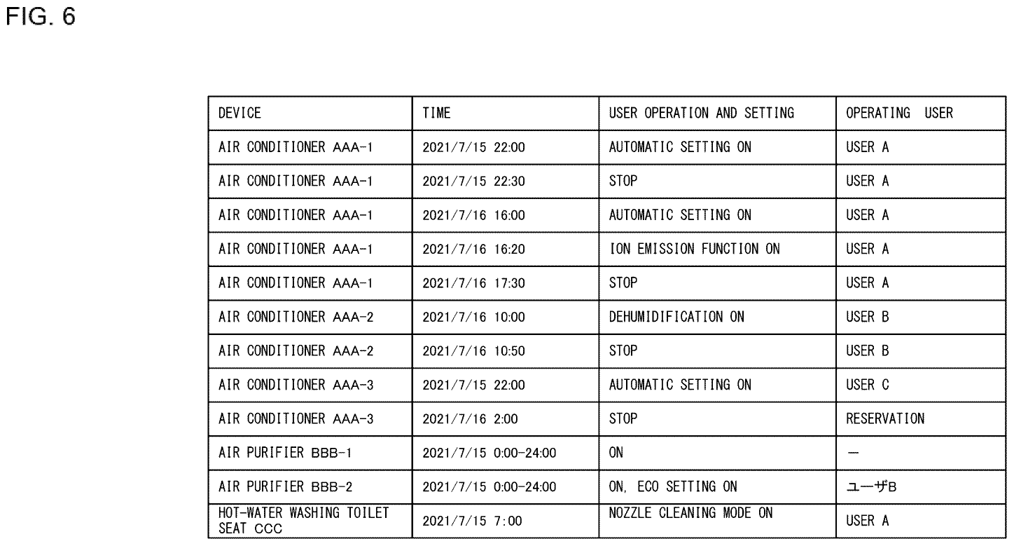

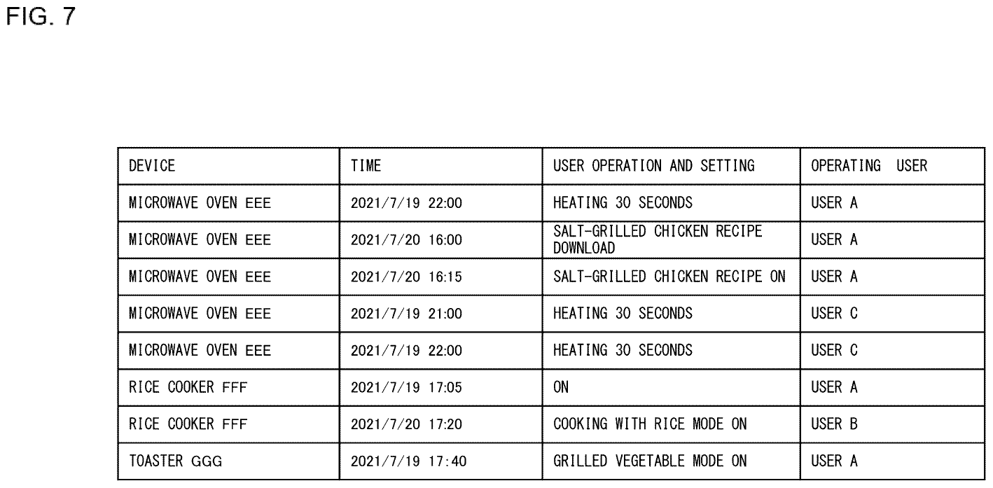

FIG. 6 shows examples of operation information for environmental control devices and seasonal devices. FIG. 7 shows examples of operation information of cooking devices. The operation information includes identification information of devices 12 (“device” column), the times when the devices 12 operated or a user operation was input to the devices 12 (“time” column), and information indicating the user operation input to the devices 12 or the status set on the devices 12 (“user operation and setting” column). The identification information of the devices 12 may include the types of the devices 12 (e.g., washing machine, etc.) and the control numbers of the devices 12. The operation input to the devices 12 may include a user operation instructing whether to turn on or off the operation.

The operation information further includes identification information (“operating user” column) of the users who operated the devices 12 (operating users). For example, each device 12 may include a user operation reception unit, which is an interface that receives a user operation that instructs to operate. The device 12 may set the user operation and setting information and the information of the operating user that are input to the user operation reception unit as the operation information. The device 12 may also use detection results from the sensors 14 to identify the user who input the user operation to the device 12. For example, the device 12 may identify the operating user by comparing the information of the operating user detected by the sensors 14 with the information for authentication of the users stored in advance in the device 12, and may set the information of the identified operating user as the operation information.

For example, if the sensors 14 are cameras (image sensors), the sensors 14 may capture an image of the operating user. The device 12 may identify the operating user by comparing a camera image capturing the operating user with an image of each user stored in advance in the device. As an exemplary variation, the sensors 14 may transmit camera images capturing the operating user to the information processing device 18. The operation information acquisition unit 54 of the information processing device 18 may identify the operating user by comparing the camera images with the image of each user stored in advance in the device 12, and add information of the identified user to the operation information transmitted from the device 12. Alternatively, a processor in each sensor 14 may perform the process of identifying the user, and the sensor 14 may transmit information indicating the identified user to the device 12 or the information processing device 18.

Returning to FIG. 5, the linking unit 56 of the information processing device 18 determines the attributes to be provided to the operation information of the device 12 acquired by the operation information acquisition unit 54 by referring to the device and location memory stored in the device and location rule memory unit 36 and the location and attribute rules stored in the location and attribute rule memory unit 38 (S11).

In the first embodiment, the linking unit 56 identifies whether the operation information acquired by the operation information acquisition unit 54 is the operation information of the device 12 installed in a shared space used by multiple users or the operation information of the device 12 installed in a specific space used by a specific user. The linking unit 56 determines to provide an attribute indicating that the operation is related to multiple users in the environment to the operation information of the device 12 installed in the shared space used by multiple users. On the other hand, the linking unit 56 determines to provide an attribute indicating that the operation is associated with a specific user in the environment to the operation information of the device 12 installed in the specific space used by the specific user.

An example of attribute determination is shown below. In the device and location rules (FIG. 3), “air conditioner AAA-1” shown in FIG. 6 is indicated as being installed in a kitchen. In the location and attribute rules (FIG. 4), the kitchen is mapped to all the users (the user A, the user B, and the user C) as multiple users. Therefore, the linking unit 56 determines to provide to the operation information of “air conditioner AAA-1” attribute information indicating that the operation is associated with all the users (the user A, the user B, and the user C) who use the given space as household data, for example.

Another example of attribute determination is shown below. In the device and location rules (FIG. 3), “air conditioner AAA-2” shown in FIG. 6 is indicated as being installed in a western-style room 1. In the location and attribute rules (FIG. 4), the western-style room 1 is mapped to specific users (the user A and the user B). Therefore, the linking unit 56 determines to provide to the operation information of “air conditioner AAA-2” attribute information indicating that the operation is associated with the specific users (the user A and the user B).

Yet another example of attribute determination is shown below. Meanwhile, in the device and location rules (FIG. 3), “air conditioner AAA-3” shown in FIG. 6 is indicated as being installed in a western-style room 2. Further, in the location and attribute rules (FIG. 4), the western-style room 2 is mapped to a specific user (the user C). Therefore, the linking unit 56 determines to provide to the operation information of “air conditioner AAA-3” attribute information indicating that the operation is associated with the specific user (the user C).

The linking unit 56 generates post-processing operation information obtained by providing the attribute determined in S11 to the operation information of the device 12 acquired by the operation information acquisition unit 54 (S12). The operation information output unit 58 stores the post-processing operation information generated by the linking unit 56 in the post-processing operation information memory unit 42 (S13). When multiple users reside in one house as a family, the post-processing operation information provided with attributes indicating all the users can be considered to be operation information treated as family data. The post-processing operation information provided with attributes indicating specific users can also be considered to be operation information treated as personal data.

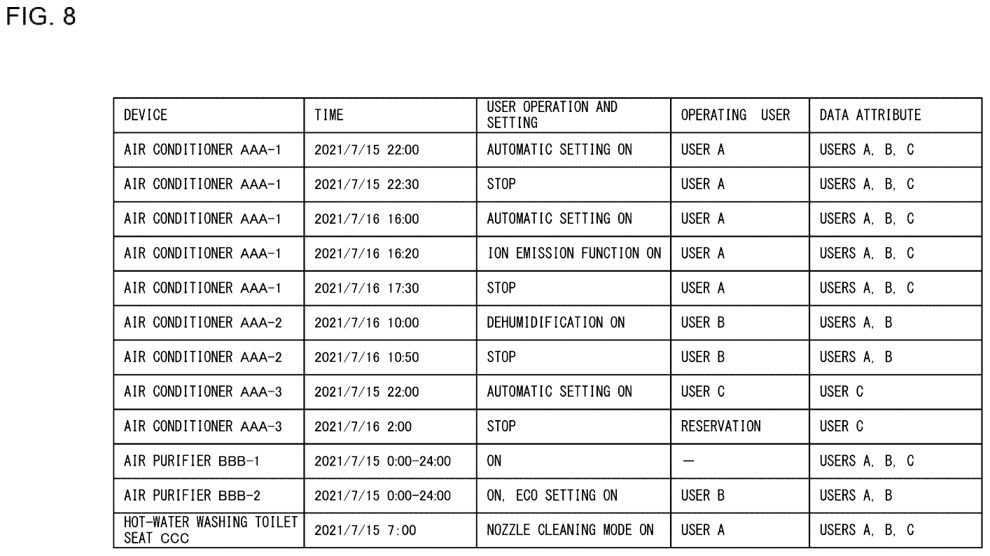

FIG. 8 shows examples of the post-processing operation information. The post-processing operation information in the figure is obtained by adding attribute information (“data attribute” column) on the user related to the operation to the operation information shown in FIG. 6. For example, attributes indicating that the information is related to all the users (the user A, the user B, and the user C) are added to the operation information for “air conditioner AAA-1.” Further, attributes indicating that the information is related to specific users (the user A and the user B) are added to the operation information for “air conditioner AAA-2.” Further, an attribute indicating that the information is related to a specific user (the user C) is added to the operation information for “air conditioner AAA-3.”

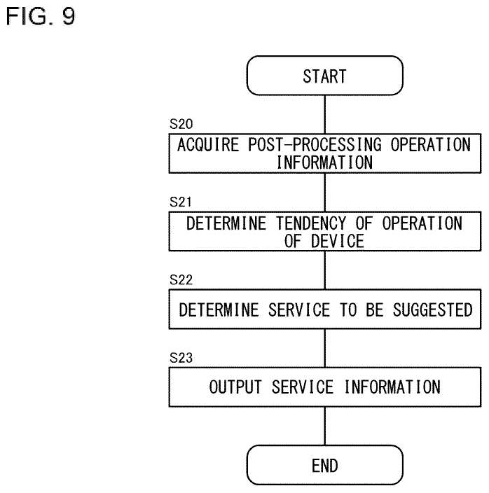

FIG. 9 is also a flowchart showing the operation of the information processing device 18 according to the first embodiment. The figure mainly shows the operation of the service suggestion unit 52 of the information processing device 18, and specifically shows an operation of suggesting a service to a user existing in a predetermined environment.

The service selection unit 60 of the information processing device 18 reads the post-processing operation information stored in the post-processing operation information memory unit 42 (S20). The service selection unit 60 groups the post-processing operation information for each of the values of data attributes included in the post-processing operation information and derives a tendency regarding the operation of the device 12 for each value of the data attributes (S21). The values of the data attributes in the first embodiment are values indicating users related to the operation who are also referred to as “related users” below. The values of the related users include, for example, “user A, user B, and user C” indicating all the users, and “user A and user B” and “user C” indicating specific users. The service selection unit 60 according to the first embodiment derives the operation tendency of the device 12 for each value of the related user.

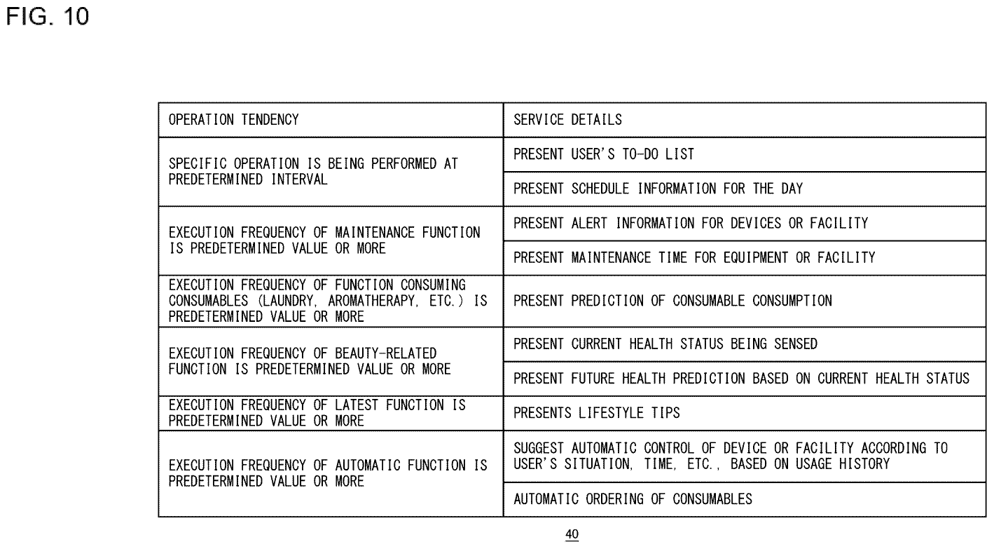

FIG. 10 shows examples of service decision rules. The service decision rules stored in the service decision rule memory unit 40 are information that maps the operation tendencies of the device 12 to the service details to be suggested to the user. The service decision rules may be set by the manufacturer of the device 12 or the provider of the service, and may be transmitted from the manufacturer of the device 12 or the provider of the service to the information processing device 18. The information processing device 18 may further include a rule registration unit (not shown) that receives the service decision rules transmitted from the manufacturer of the device 12 or the provider of the service and stores the service decision rules in the service decision rule memory unit 40. The service decision rules may be set for each value of the related user, for example, service decision rules for operation information provided with attributes for all the users and service decision rules for operation information provided with attributes of specific users may be set.

With reference to the service decision rules stored in the service decision rule memory unit 40, if service details corresponding to the operation tendency of the device 12 for each value of the related user derived in S21 is set in the service decision rules, the service selection unit 60 selects the service details as a service for the related user (S22).

The service decision rules shown in FIG. 10 are service decision rules for operation information provided with a data attribute indicating all users. The service decision rules include a rule that sets the frequency (frequency as a threshold value) of a predetermined operation performed by a device 12 installed in a space used by all users as the operation tendency of the device 12. For example, in FIG. 10, this applies to the rule that defines “the frequency of the execution of a maintenance function is a predetermined value or more” as the operation tendency. The service selection unit 60 collects multiple pieces of operation information provided with data attributes indicating all users so as to derive the frequency (the actual frequency) at which the above predetermined operation has been performed. If the derived actual frequency satisfies a frequency condition set by the rule, the service selection unit 60 selects a service for all the users set by the rule.

The service decision rule related to operation information provided with a data attribute indicating a specific user may also include a rule that sets the frequency (frequency as a threshold value) of a predetermined operation performed by a device 12 installed in a space used by the specific user as the operation tendency of the device 12. The service selection unit 60 collects multiple pieces of operation information provided with a data attribute indicating the specific user so as to derive the frequency (the actual frequency) at which the above predetermined operation has been performed. If the derived actual frequency satisfies a frequency condition set by the service decision rule, the service selection unit 60 selects a service for the specific user set by the rule.

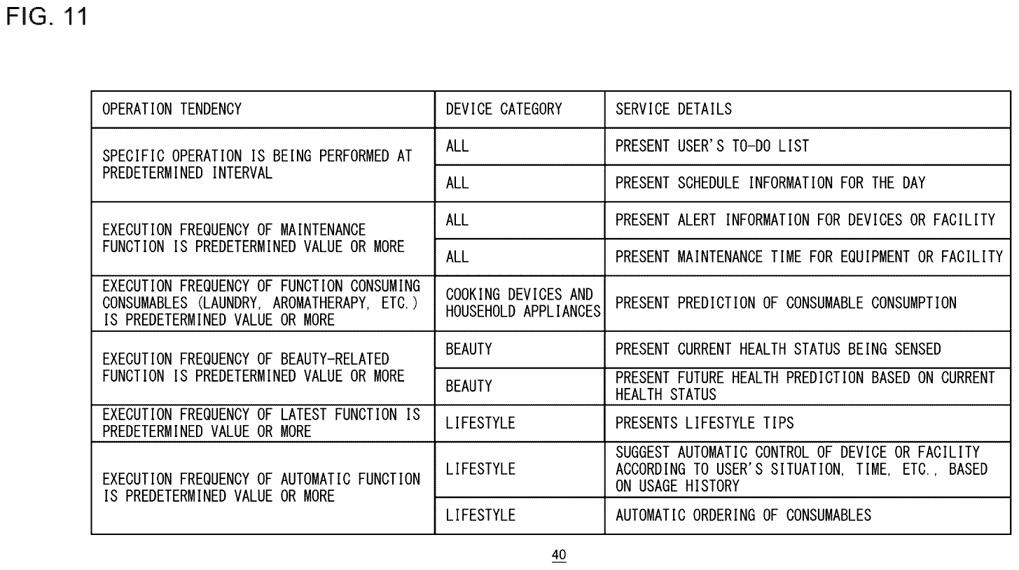

FIG. 11 shows other examples of service decision rules. As shown in FIG. 11, the service decision rule may be information that maps a set of the operation tendency and category of a device 12 to service details to be suggested to the user. As shown in FIG. 3, the device and location rules may store a correspondence relationship between the category of the device 12 and the identification information of the device 12. The service selection unit 60 may identify the category of the device based on the identification information of the device indicated by the operation information of the device 12, collect the operation information for each related user and each category of the device 12, and derive the operation tendency of the device 12 for each related user and each category of the device 12.

With reference to a service decision rule in the format shown in FIG. 11, and if service details corresponding to the operation tendency of the device 12 for each related user and for each category of the device 12 is set in the service decision rule, the service selection unit 60 may select the service details as a service for the related user. The service content may be selected as a service for the related user. This allows for easy selection of an appropriate service according to the category of the device 12.

The service decision rules shown in FIGS. 10 and 11 are now supplementarily explained. It is assumed that the operation information mapped to the attributes of all users has a strong aspect of dependence on the environment or device 12; in other words, it is assumed that the operation details are easily determined depending on the environment or device 12. Therefore, the service decision rules may map the operation tendencies that are based on the operation information mapped to the attributes of all users to the services mapped to the environment or device 12. With reference to the service decision rules, as the service for all the users, the service selection unit 60 may select the service mapped to the environment or the device 12, which is mapped to the operation tendencies that are based on the operation information mapped to the attributes of all the users.

On the other hand, it is assumed that the operation information mapped to the attribute of a specific user has a strong aspect of dependence on the specific user; in other words, it is assumed that the operation details are likely to be determined depending on the intention or preference of the user. Therefore, the service decision rules may map the operation tendencies that are based on the operation information mapped to the attribute of the specific user to the service determined based on the information on the specific user. The information on the specific user may include, for example, attribute information of the specific user and a usage history of the device 12 or other digital devices (such as information terminal 16) by the specific user.

For example, the service selection unit 60 may determine the details of a “future health prediction based on current health status” service shown in FIGS. 10 and 11 using information registered by the specific user to whom the service is provided. For example, the service selection unit 60 may determine the details of the service using the specific user's exercise information acquired by a smartwatch of the specific user and registered in a predetermined server, or the specific user's personal information (e.g., sex, age, disease history, etc.) registered in the server from the specific user's information terminal 16.

The service selection unit 60 may select “future health prediction based on current health status” as a service for the specific user based on the operation information provided with the data attribute indicating the specific user. The service selection unit 60 may then determine the specific details of the future health prediction to be presented to the user using the specific user's exercise information and personal information (e.g., sex, age, disease history, etc.) registered in the predetermined server.

Returning to FIG. 9, the service information output unit 62 of the information processing device 18 outputs the information on the service for a related user selected by the service selection unit 60 to the device used by the related user (S23). In the case of the service decision rules shown in FIGS. 10 and 11, the information on the service output by the service information output unit 62 may include (1) alert information on the device or facility, (2) maintenance timing of the device or facility, (3) information on predicted consumption of consumables, (4) information on current health condition, etc.

The service information output unit 62 transmits information on a service for all users (e.g., the user A, the user B, and the user C) to the devices used by all users (e.g., the information terminal 16a, the information terminal 16b, and the information terminal 16c) for display. Further, the service information output unit 62 transmits information on a service for a specific user (e.g., the user C) to the device used by the specific user (e.g., the information terminal 16c) for display.

In the first embodiment, the service information output unit 62 causes information on a service suggested to the user to be displayed on a device (information terminal 16) different from the information processing device 18. As an exemplary variation, if the information processing device 18 has a display unit, the service information output unit 62 may display the information on the service suggested to the user on the display unit of the information processing device 18. Further, the information terminal 16 may include a terminal shared by multiple users (e.g., a television set installed in a living room). In this case, the service information output unit 62 may display information on a service for all users on the shared terminal. Further, the service information output unit 62 may store one or both of the information on the service for all users and the information on the service for the specific user in a predetermined memory unit (e.g., a database server external to the information processing device 18).

According to the information processing system 10 according to the first embodiment, the operation information of the device 12 is classified into information for all users or information for a specific user in accordance with the installation position of the device 12. This allows for the generation of operation information of the device in consideration of an environment where multiple spaces and multiple users exist (e.g., a house where multiple users reside as a family). In addition, according to the information processing system 10 according to the first embodiment, a service for users is selected based on the operation information linked to all users or specific users in a predetermined environment. In other words, the system selects a service for users based on the installation location of the device 12 and the operation status of the device 12. This allows a service reflecting the user's intentions and preferences to be suggested to the user.

More specifically, for example, using the operation information of an air conditioner installed in a living room where the family spends time together, a service can be suggested to the user based on the temperature setting included in the operation information and the preferences of the family as a whole (e.g., sensitiveness to the heat, sensitiveness to the cold, liking for natural wind) estimated from the information of an operation mode such as cooling and drying. Meanwhile, using the operation information of an air conditioner installed in the bedroom of a son in the family, a service different from that for the family can be suggested to the son based on the son's individual preference estimated from the operation information.

The present disclosure has been described based on the first embodiment. The first embodiment is intended to be illustrative only, and it will be understood by those skilled in the art that various modifications to constituting elements and processes in the first embodiment could be developed and that such modifications are also within the scope of the present disclosure.

A first exemplary variation of the information processing system 10 according to the first embodiment will be explained. Even in the case of operation information of a device 12 installed in a space used by a specific user, the linking unit 56 of the information processing device 18 may map the operation information of the device 12 to all users as an exception if a predetermined setting has been applied to the device 12. For example, the linking unit 56 may detect that a predetermined setting has been applied to the device 12 with reference to information on the settings applied to the device 12 that is stored in a predetermined memory area.

The predetermined setting may be that the log information of the device 12 is allowed to be viewed by other users (or has been viewed by other users) other than the specified user who uses the space in which the device 12 is installed. The predetermined setting may also be that the use of the device 12 is restricted (e.g., the available functions or time is restricted) by other users other than the specified user. For example, the operation information of a game device installed in a western-style room 2 is usually mapped to the attributes of the user C. However, if the user A has set a restriction on the use of the game device, the operation information of the game device in the western-style room 2 may be mapped to the attributes of all users as an exception, since there is a strong aspect of environmentally dependent use of the game device.

According to the information processing system 10 according to the first exemplary variation, the accuracy of the classification of the operation information of devices 12 can be improved in consideration of the settings for the devices 12.

A second exemplary variation of the information processing system 10 according to the first embodiment will be explained. The linking unit 56 of the information processing device 18 may be configured in such a way that even in the case of operation information of a device 12 installed in a space used by all users, the operation information of the device 12 can be mapped to a specific user as an exception if a predetermined attribute is included in the attributes of all the users. This specific user may be one or more users who have the above predetermined attribute among all the users.

For example, the information processing device 18 may further include a user attribute memory unit that stores attributes for each of a plurality of users residing in the same house and constituting a family. The linking unit 56 of the information processing device 18 may identify the attributes of all users residing in the same house with reference to the attribute information stored in the user attribute memory unit. The attributes for each of the multiple users may include at least one of sex, age, occupation, hobbies, and preferences.

If the attributes of the multiple users residing in the same house include a housewife, the linking unit 56 may exceptionally map the operation information of the device 12 installed in the living room and whose operation time is during daytime hours (e.g., from 9 AM to 5 PM) to the attributes of a specified user. The specified user here may be a user with an attribute being housewife or may be an operator of the device 12. On the other hand, as per the principle, the linking unit 56 may map the operation information of the device 12 installed in the living room and whose operation time is other than daytime hours (including nighttime, e.g., from 5 PM to 9 AM) to the attributes of all users.

According to the information processing system 10 according to the second exemplary variation, the accuracy of the classification of the operation information of devices 12 can be improved in consideration of the attributes of the users.

A third exemplary variation of the information processing system 10 according to the first embodiment will be explained. The linking unit 56 of the information processing device 18 may map to all users the operation information of a device 12 whose installation space is not specified. For example, in the device and location rules in FIG. 3, the installation location of “vacuum cleaner DDD-2” is not set. This is because “vacuum cleaner DDD-2” is used for cleaning in multiple rooms. The linking unit 56 may map the operation information of “vacuum cleaner DDD-2,” whose installation location is not set in the device and location rules, to the attributes of all the users. This is because a devices 12 whose installation location is not set may be used in various spaces in the environment, and the operation thereof may be associated with all users in the environment. The information processing system 10 according to the third exemplary variation more easily allows for correct classification of the operation information of a device 12 whose installation space is not specified.

The linking unit 56 may suppress the provision of data attributes to the operation information of the device 12 whose installation space is not specified, for example, the operation information of the device 12 whose installation location is not set by the device and location rules. The service selection unit 60 of the information processing device 18 may exclude the operation information to which data attributes are not provided from operation information used for service selection. In other words, using only operation information provided with data attributes, i.e., the operation information of a device 12 installed in a space that is identified, the service selection unit 60 may select a service to be suggested to the user for each value of the data attributes.

A fourth exemplary variation of the information processing system 10 according to the first embodiment will be explained. In the first embodiment, the device and location rules and the location and attribute rules are provided separately. However, as an exemplary variation, a rule (device and attribute rule) may be provided that directly maps a device 12 and data attributes (based on the location of the device 12). The linking unit 56 of the information processing device 18 may map data attributes to the operation information of a device 12 with reference to the device and attribute rules. Further, the entity that maps the data attributes to the operation information of a device 12 may be a device other than the information processing device 18, for example, the device 12. In this case, the operation information acquisition unit 54 of the information processing device 18 may acquire the operation information of the device 12 mapped to the data attributes (corresponding to the operation information after the processing according to the first embodiment) from an external device (e.g., the device 12).

A fifth exemplary variation of the information processing system 10 according to the first embodiment will be explained. In the first embodiment, both a function of analyzing the operation information of a device 12 (operation information processing unit 50) and a function of suggesting a service to the user (service suggestion unit 52) are implemented in the same information processing device 18. As an exemplary variation, a function of analyzing the operation information of a device 12 (operation information processing unit 50) and a function of suggesting a service to the user (service suggestion unit 52) may be implemented in different information processing devices 18.

### Second Embodiment

The second embodiment according to the present disclosure will be explained focusing mainly on the differences from the first embodiment, and explanations on common features will be omitted as appropriate. The features of the second embodiment can be arbitrarily combined with those of the first embodiment or exemplary variations. Constituting elements of the second embodiment that are the same as or correspond to constituting elements of the first embodiment shall be described being denoted by the same reference numerals as appropriate.

An overview of the second embodiment will be explained now. In the same way as in the first embodiment, the second embodiment also proposes a technology for supporting accurate classification of operation information of devices. The information processing device 18 according to the second embodiment acquires operation information of a device 12 and classifies the acquired operation information of the device 12 into a predetermined category, that is, into one of multiple predetermined categories. The information processing device 18 associates the operation information of the device 12, the category into which the operation information is classified, and user information in which the operation of the device 12 is set. The information processing device 18 outputs the associated operation information of the device. When a user operates the device, the user is likely to operate the device while considering whether the user operation on the device is intended for the user himself/herself, or for the user himself/herself and unspecified users. According to the information processing device 18 of the second embodiment, by focusing on the operation mode of the device 12 or the user operation on the device 12 and by linking and managing the operation information of the device 12 and the user information, the tendency (intentions and preferences) of the user can be estimated with high accuracy.

The predetermined categories used for classifying the operation information of the device 12 include at least one of a simple operation and a complex operation. The simple operation is an operation of the device 12 that is set using a function or mode that is preset for the device 12. The complex operation is an operation of the device 12 that is set while changing a function or mode that is preset for the device 12. Classification of the operation information of the device 12 in accordance with these categories allows for more accurate estimation of user tendencies. More specifically, the simple operation is an operation that uses the initial settings (in other words, default settings) provided in advance in the device 12. Therefore, it can be estimated that the operation information of device 12 classified as the simple operation has a low tendency of indicating the user's intentions and preferences. Further, the complex operation is based on the operation settings of the device changed by the user himself/herself, not on the default settings provided in the device 12 in advance. Therefore, it can be estimated that the operation information of device 12 classified as the complex operation has a high tendency of indicating the user's intentions and preferences.

As an exemplary variation, the predetermined categories used for classifying the operation information of the device 12 may further include a frequent operation. The frequent operation, which can also be considered as a user's favorite operation, is an operation of the device 12 set to exceed a predetermined frequency during a certain period of time. The frequent operation is an operation of the device 12 performed many times during a certain period of time and is frequently used by the user. Therefore, it can be estimated that the operation information of device 12 classified as the frequent operation has a high tendency of indicating the user's intentions and preferences.

The details of the second embodiment will be explained now. In the second embodiment, the simple operation of the device 12 is defined as an operation of the device 12 triggered by a user operation with a relatively low level of detail, for example, an operation of the device 12 based on a user operation that instructs an autonomous operation of the device 12 (such as turning on an automatic operation). The complex operation of device 12 is defined as an operation of device 12 triggered by a user operation with a relatively high level of detail, for example, an operation of device 12 based on a user operation that instructs to operate in a mode specified by the user (in other words, a user operation that specifies the operation mode in detail, etc.). The level of detail of a user operation represents the degree of detail with which the operation mode of the device 12 is instructed. The level of detail of a user operation may be determined using at least one of the following: the depth of the user operation hierarchy, the complexity of the user operation, and the number of user operation input entries.

Many devices such as home appliances and home equipment can receive multiple types of user operations from the user with different levels of detail, and operate in accordance with the type of operation received from the user. The operation of a device triggered by a user operation with a relatively high level of detail is considered to be an operation that reflects the intentions and preferences of a specific user such as the operator. On the other hand, the operation of a device triggered by a user operation with a relatively low level of detail is considered to be an operation that takes into account all users in the environment where the device is installed.

Therefore, the information processing system according to the second embodiment analyzes the operation information of the device according to the type of user operation that has been entered by the user for the device and that has triggered the operation of the device. More specifically, the information processing system according to the second embodiment links the operation information of the device involved in a user operation with a relatively high level of detail (i.e., operation information of the device on a detailed operation) to a specific user. On the other hand, the information processing system links the operation information of the device involved in a user operation with a relatively low level of detail (i.e., operation information of the device on a simple operation) to all users. In this way, the information processing system separates the operation information that includes the user's clear intentions or preferences from the operation information that does not include the user's clear intentions or preferences, and suggests a service to the user according to the results of the separation.

A user operation with a relatively low level of detail can be considered to be a user operation in a shallow hierarchy (first layer described below) and can also be considered as a user operation with a relatively low level of complexity. The user operation with a relatively low level of detail may include a user operation of simply turning the power of the device 12 on or off. On the other hand, the user operation with a relatively high level of detail can be considered as a user operation in a deep hierarchy (second layer described below) and can also be considered as a user operation with a relatively high level of complexity. The user operation with a relatively high level of detail may include a user operation that instructs a change in the settings of the device 12. For example, a user operation that instructs a change in the settings of the device 12 includes turning on a cooking mode in a rice cooker or turning on an ECO setting in an air conditioner, etc.

A user operation with a relatively low level of detail may include a user operation of instructing an autonomous operation of the device 12, in other words, a user operation that instructs the device 12 to operate in an autonomously determined mode. A user operation of instructing an autonomous operation of the device 12 includes, for example, “automatic setting ON” (user operation in which the device is left to determine the operation mode) in an air conditioner or the like. On the other hand, the user operation with a relatively high level of detail may include a user operation that instructs an operation in a user-specified mode. For example, a user operation that instructs an operation in a user-specified mode includes turning on a cooking mode in a rice cooker or turning on an ECO setting in an air purifier, etc.

Further, a user operation with a relatively low level of detail may include a user operation that requires a relatively small number of user operation input entries to instruct the device 12. In other words, a user operation with a relatively low level of detail may include a user operation in which the number of user operation input entries required to cause the device 12 to start an operation intended by the user is less than a predetermined threshold (e.g., two times). Further, a user operation with a relatively high level of detail may include a user operation that requires a relatively large number of user operation input entries to instruct the device 12. In other words, a user operation with a relatively high level of detail may include a user operation in which the number of user operation input entries required to cause the device 12 to start an operation intended by the user is a predetermined threshold (e.g., two times) or more.

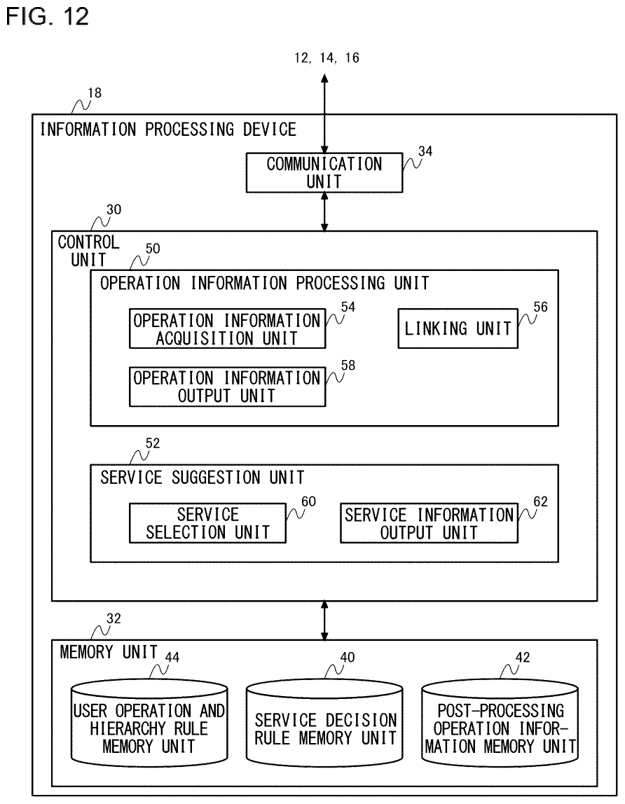

The configuration of the information processing system 10 according to the second embodiment is the same as that of the information processing system 10 according to the first embodiment shown in FIG. 1. FIG. 12 is a block diagram showing functional blocks of an information processing device 18 according to the second embodiment. The information processing device 18 according to the second embodiment does not include a device and location rule memory unit 36 and a location and attribute rule memory unit 38 but includes a user operation and hierarchy rule memory unit 44 instead. That is, the information processing device 18 according to the second embodiment stores user operation and hierarchy rules instead of device and location rules and location and attribute rules as rules for classifying operation information. The other functional blocks of the information processing device 18 according to the second embodiment are the same as those of the information processing device 18 according to the first embodiment.

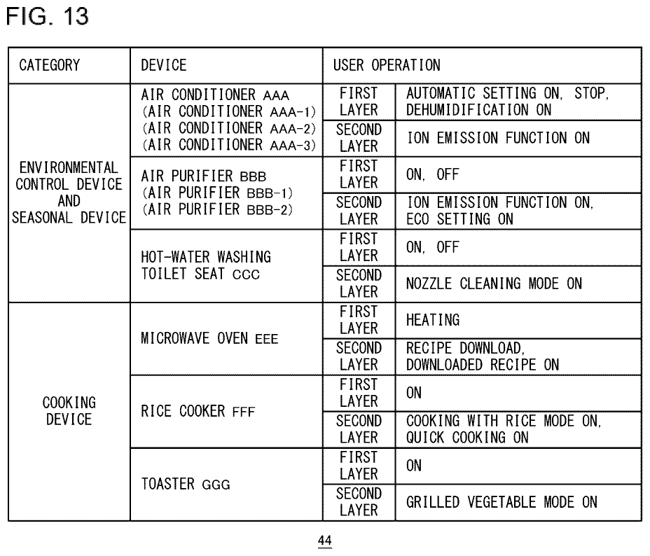

The user operation and hierarchy rule memory unit 44 stores data of predetermined user operation and hierarchy rules. FIG. 13 shows examples of the user operation and hierarchy rules. The user operation and hierarchy rules are data indicating the level of detail of each of multiple types of user operations that can be input by the user for each device 12. In other words, the user operation and hierarchy rules are data that indicate, for each device 12, the corresponding rules for the multiple types of user operations received by the device 12 and the level of detail of each user operation. In the second embodiment, user operations with a relatively low level of detail are classified as first-layer user operations, and user operations with a relatively high level of detail are classified as second-layer user operations.

The user operation and hierarchy rules may be set by the manufacturer of the device 12 or the provider of the service, and may be transmitted from the manufacturer of the device 12 or the provider of the service to the information processing device 18. The information processing device 18 may further include a rule registration unit (not shown) that receives the user operation and hierarchy rules transmitted from the manufacturer of the device 12 or the provider of the service and stores the user operation and hierarchy rules in the user operation and hierarchy rule memory unit 44.

The operation of the information processing system 10 according to the second embodiment with the above configuration will now be described. The operation of processing the operation information of a device 12 installed in a predetermined environment shown in the flowchart in FIG. 5 is also applicable to the information processing device 18 according to the second embodiment. The environment described above is also assumed to be a house in which a user A, a user B, and a user C reside.

The operation information acquisition unit 54 of the information processing device 18 acquires the operation information (e.g., the operation information shown FIGS. 6 and 7) transmitted from the device 12 (S10). The linking unit 56 of the information processing device 18 determines the attributes to be provided to the operation information of the device 12 acquired by the operation information acquisition unit 54 by referring to the user operation and hierarchy rules stored in the user operation and hierarchy rule memory unit 44 (S11).

In S11, the linking unit 56 maps to all users the operation information involved in a user operation with a relatively low level of detail among the operation information of the device 12, i.e., the operation information in which a user operation classified into the first layer in the user operation and hierarchy rules is recorded. Further, the linking unit 56 maps to a specific user the operation information involved in a user operation with a relatively high level of detail among the operation information of the device 12, i.e., the operation information in which a user operation classified into the second layer in the user operation and hierarchy rules is recorded.

For example, if certain operation information indicates that a user operation “automatic setting ON” has been entered for “air conditioner AAA-1,” the linking unit 56 determines to provide attribute information indicating the association with all users (the user A, the user B, and the user C) to the operation information based on the user operation and hierarchy rules. Further, if certain operation information indicates that a user operation “ion emission function ON” has been entered for “air conditioner AAA-1,” the linking unit 56 determines to provide attribute information indicating the association with a specific user to the operation information based on the user operation and hierarchy rules.

Further, if certain operation information indicates that a user operation “ON” has been entered for “air purifier BBB-1,” the linking unit 56 determines to provide attribute information indicating the association with all the users (the user A, the user B, and the user C) to the operation information based on the user operation and hierarchy rules. Further, if certain operation information indicates that a user operation “eco setting ON” has been entered for “air purifier BBB-2,” the linking unit 56 determines to provide attribute information indicating the association with a specific user to the operation information based on the user operation and hierarchy rules.

In the second embodiment, in associating the specific with the operation information, the data of the operator indicated by the operation information is associated. This is because the user operation indicated by the operation information is considered to reflect the intentions and preferences of the operator. As an exemplary variation, a structure may be employed where in associating a specific user with operation information, data other than that of the operator indicated by the operation information can be associated. For example, the information processing device 18 may include a device and location rule memory unit 36 and a location and attribute rule memory unit 38 in the same manner as in the first embodiment. In this case, the specific user to be associated with the operation information may be a user who uses a space in which the device 12 is installed, in other words, a user associated with the space in which the device 12 is installed.

Subsequent operations regarding the classification of the operation information are the same as those in the first embodiment. The linking unit 56 generates post-processing operation information obtained by providing the attribute determined in S11 to the operation information of the device 12 acquired by the operation information acquisition unit 54 (S12). The operation information output unit 58 stores the post-processing operation information generated by the linking unit 56 in the post-processing operation information memory unit 42 (S13).

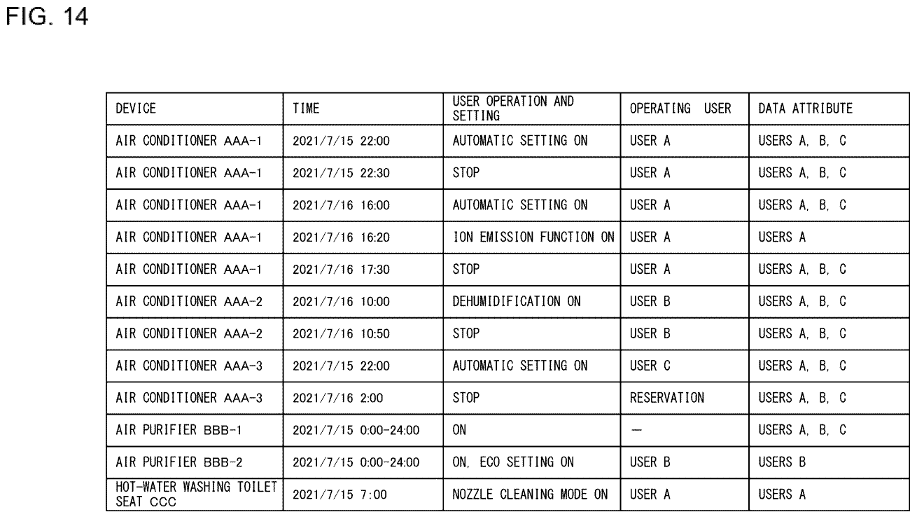

FIG. 14 shows examples of the post-processing operation information. The post-processing operation information in the figure is obtained by adding attribute information (“data attribute” column) on the user related to the operation to the operation information shown in FIG. 6. The “data attribute” column contains attribute values corresponding to the layers of user operations (in other words, the level of detail of user operations) indicated by respective pieces of operation information.

A service suggestion operation by the information processing device 18 according to the second embodiment is the same as the service suggestion operation of the information processing device 18 according to the first embodiment explained in relation to the flowchart in FIG. 9. The service selection unit 60 of the information processing device 18 reads the post-processing operation information stored in the post-processing operation information memory unit 42 (S20).

The service selection unit 60 selects a service for all users (e.g., the user A, the user B, and the user C) using the operation information of the device 12 involved in a user operation with a relatively low level of detail. In the second embodiment, the service selection unit 60 selects a service for all users using the post-processing operation information provided with data attributes indicating all users. Further, the service selection unit 60 selects a service for specific users (e.g., some of the user A, the user B, and the user C) using the operation information of the device 12 involved in a user operation with a relatively high level of detail. In the second embodiment, the service selection unit 60 selects a service for specific users using the post-processing operation information provided with data attributes indicating the specific users.

More specifically, the service selection unit 60 groups the post-processing operation information for each of the values of data attributes included in the post-processing operation information and derives an operation tendency of the device 12 for each value of the data attributes (the value of a related user) (S21). With reference to the service decision rules stored in the service decision rule memory unit 40 illustrated in FIG. 10, if service details corresponding to the operation tendency of the device 12 for each value of the related user derived in S21 is set, the service selection unit 60 selects the service details as a service for the related user (S22).

As explained in the first embodiment, the service determination rules shown in FIG. 10 include rules that define the frequency (frequency as a threshold value) at which the device 12 has performed a predetermined operation as the operation tendency of the device 12. The service selection unit 60 derives the frequency (actual frequency) at which the above predetermined operation has been performed based on multiple pieces of operation information related to operations with a relatively low level of detail, i.e., multiple pieces of operation information provided with data attributes indicating all users. If the derived actual frequency satisfies a frequency condition set by the service decision rule, the service selection unit 60 selects a service for all the users set by the rule. As explained in the first embodiment, the service selection unit 60 may select a service for a specific user based on the frequency at which the device 12 has performed the predetermined operation.

The service information output unit 62 of the information processing device 18 outputs the information on the service for a related user selected by the service selection unit 60 to the device used by the related user (S23). In the same way as in the first embodiment, the service information output unit 62 transmits information on a service for all users (e.g., the user A, the user B, and the user C) to the devices used by all users (e.g., the information terminal 16a, the information terminal 16b, and the information terminal 16c) for display in the second embodiment. Further, the service information output unit 62 transmits information on a service for a specific user (e.g., the user C) to the device used by the specific user (e.g., the information terminal 16c) for display.

According to the information processing system 10 according to the second embodiment, the operation information of the device 12 is classified into information for all users or information for a specific user in accordance with the level of detail of a user operation that has triggered the operation of the device 12. This allows the operation information that includes the user's clear intentions or preferences to be accurately separated from the operation information that does not include the user's clear intentions or preference. Further, according to the information processing system 10 according to the second embodiment, the service for the user is selected according to the level of detail of a user operation that has triggered the operation of the device 12. This allows a service of the device 12 reflecting the user's intentions and preferences to be suggested to the user.

The present disclosure has been described based on the second embodiment. The second embodiment is intended to be illustrative only, and it will be understood by those skilled in the art that various modifications to constituting elements and processes in the second embodiment could be developed and that such modifications are also within the scope of the present disclosure.

An exemplary variation of the information processing system 10 according to the second embodiment will be explained. In the second embodiment, both a function of analyzing the operation information of a device 12 (operation information processing unit 50) and a function of suggesting a service to the user (service suggestion unit 52) are implemented in the same information processing device 18. As an exemplary variation, a function of analyzing the operation information of a device 12 (operation information processing unit 50) and a function of suggesting a service to the user (service suggestion unit 52) may be implemented in different information processing devices 18.

Optional combinations of the aforementioned embodiments and exemplary variations will also be within the scope of the present disclosure. New embodiments resulting from the combinations will provide the advantages of the embodiment and the exemplary variations combined. It will be obvious to those skilled in the art that the function to be achieved by each constituent requirement described in the claims are achieved by each constituting element shown in the embodiments and in the exemplary variations or by a combination of the constituting elements.

### Additional Notes

The following technologies are disclosed by the above description of the embodiments and exemplary variations.

### Technology 1-1

An information output method including:
acquiring operation information of a device installed in a space;
using information linking the operation information of the device with the space in which the device is provided so as to:
map operation information of a device installed in a shared space used by a plurality of users to the plurality of users, and
map operation information of a device installed in a specific space used by a specific user to the specific user; and
outputting at least one of the operation information mapped to the plurality of users and the operation information mapped to the specific user.

According to this information output method, operation information of a device is classified into information of a plurality of users or information of a specific user in accordance with a location where the device is installed. This allows for the generation of operation information of a device in consideration of an environment where multiple users exist (e.g., a house where multiple users reside as a family). Further, operation information output by this method can be used to provide a service that reflects the intentions and preferences of the users.

### Technology 1-2

The information output method according to Technology 1-1, including:
based on spatial information indicating the function or type of a preset space, estimating whether the category of the space in which the device is installed is the shared space or the specific space; and
based on the estimated category of the space, identifying whether the operation information of the device is the operation information of the device installed in the shared space or the operation information of the device installed in the specific space.

This information output method allows for an increase in the accuracy of the classification of operation information of devices.

### Technology 1-3

The information output method according to Technology 1-1 or 1-2, including:
even in the case of the operation information of the device installed in the specific space, mapping the operation information of the device to the plurality of users if a predetermined setting has been applied to the device.

This information output method allows for an increase in the accuracy of the classification of operation information of devices in consideration of the settings for the devices.

### Technology 1-4

The information output method according to any one of Technology 1-1 through Technology 1-3, including:
even in the case of operation information of a device installed in a space used by the plurality of users, being able to map the operation information of the device to a specific user if a predetermined attribute is included in attributes of the plurality of users.

This information output method allows for an increase in the accuracy of the classification of operation information of devices in consideration of the attributes of users.

### Technology 1-5

The information output method according to any one of Technology 1-1 through Technology 1-4, including:
mapping operation information of a device whose installation space is not specified to the plurality of users.

According to this information output method, it becomes easier to correctly classify the operation information of a device whose installation space is not specified.

### Technology 1-6

An information output method including:
using operation information of a device installed in a shared space used by a plurality of users so as to select a service for the plurality of users;
using operation information of a device installed in a specific space used by a specific user so as to select a service for the specific user; and
outputting at least one of information on the service for the plurality of users and information on the service for the specific user.

According to this information output method, a service for users is selected in accordance with the installation location of the device and the operation status of the device. This allows a service reflecting the user's intentions and preferences to be suggested to the user.

### Technology 1-7

The information output method according to Technology 1-6, including:
outputting the information on the service for the plurality of users to a device used by the plurality of users and outputting the information on the service for the specific user to a device used by the specific user.

This information output method allows for the outputting of information on a service to a proper device.

### Technology 1-8

The information output method according to Technology 1-6 or 1-7, including:
deriving a frequency at which a predetermined operation has been performed based on a plurality of pieces of operation information of a device installed in a space used by the plurality of users and selecting a service for the plurality of users based on the frequency.

This information output method allows for the selection of a proper service for all users.

### Technology 1-9

The information processing device including:
an acquisition unit that acquires operation information of a device installed in a space;
a linking unit that uses information linking the operation information of the device with the space in which the device is provided so as to:
map operation information of a device installed in a shared space used by a plurality of users to the plurality of users; and
map operation information of a device installed in a specific space used by a specific user to the specific user; and
an output unit that outputs at least one of the operation information mapped to the plurality of users and the operation information mapped to the specific user.

According to this information processing device, operation information of a device is classified into information of a plurality of users or information of a specific user in accordance with a location where the device is installed. This allows for the generation of operation information of a device in consideration of an environment where multiple users exist (e.g., a house where multiple users reside as a family). Further, operation information output from this information processing device can be used to provide a service that reflects the intentions and preferences of the users.

### Technology 1-10

An information processing device including:
a selection unit that uses operation information of a device installed in a shared space used by a plurality of users so as to select a service for the plurality of users, and
that uses operation information of a device installed in a specific space used by a specific user so as to select a service for the specific user; and
an output unit that outputs at least one of information on the service for the plurality of users and information on the service for the specific user.

According to this information processing device, a service for users is selected in accordance with the installation location of the device and the operation status of the device. This allows a service reflecting the user's intentions and preferences to be suggested to the user.

### Technology 1-11

A computer program including computer-implemented modules including:
a module that acquires operation information of a device installed in a space;
a module that uses information linking the operation information of the device with the space in which the device is provided so as to:
map operation information of a device installed in a shared space used by a plurality of users to the plurality of users; and
map operation information of a device installed in a specific space used by a specific user to the specific user; and
a module that outputs at least one of the operation information mapped to the plurality of users and the operation information mapped to the specific user.

According to this computer program, operation information of a device is classified into information of a plurality of users or information of a specific user in accordance with a location where the device is installed. This allows for the generation of operation information of a device in consideration of an environment where multiple users exist (e.g., a house where multiple users reside as a family). Further, operation information output by this computer program can be used to provide a service that reflects the intentions and preferences of the users.

### Technology 1-12

A computer program including computer-implemented modules including:
a module that uses operation information of a device installed in a shared space used by a plurality of users so as to select a service for the plurality of users;
a module that uses operation information of a device installed in a specific space used by a specific user so as to select a service for the specific user; and
a module that outputs at least one of information on the service for the plurality of users and information on the service for the specific user.

According to this computer program, a service for users is selected in accordance with the installation location of the device and the operation status of the device. This allows a service reflecting the user's intentions and preferences to be suggested to the user.

### Technology 2-1

An information output method including:
acquiring operation information of a device;
classifying the acquired operation information of the device into a predetermined category;
storing the category into which the operation information is classified, the operation information of the device, and the user information in which the operation of the device is set in association with one another; and
outputting the associated operation information of the device.

By outputting operation information of a device associated with a category and user information, this information output method allows for accurate classification of the operation information of the device.

### Technology 2-2

The information output method according to Technology 2-1, wherein
the category includes at least one of a simple operation that is set using a function or mode preset for the device and a complex operation that is set while changing a function or mode preset for the device.

This information output method allows for accurate classification of the operation information of the device based on the mode of the operation setting of the device.

### Technology 2-3

The information output method according to Technology 2-2, including:
mapping operation information associated with the simple operation to all users;
mapping operation information associated with the complex operation to a specific user; and
outputting at least one of the operation information mapped to all the users and the operation information mapped to the specific user.

According to this information output method, operation information of a device is classified into information of all users or information of a specific user based on the mode of the operation setting of the device. This allows the operation information that includes the user's clear intentions or preferences to be separated from the operation information that does not include the user's clear intentions or preference. Further, operation information output by this method can be used to provide a service of the device that reflects the intentions and preferences of the users.

### Technology 2-4

The information output method according to Technology 2-2 or 2-3, wherein
the simple operation is an operation that is based on a user operation instructing an autonomous operation of the device while the complex operation is an operation that is based on a user operation instructing an operation in a user-specified mode.

This information output method allows for an increase in the accuracy of the classification of operation information of devices.

### Technology 2-5

The information output method according to any one of Technology 2-2 through Technology 2-4, wherein
the simple operation is an operation that is based on a user operation that requires a small number of user operation input entries to instruct the device while the complex operation is an operation that requires a large number of user operation input entries to instruct the device.

This information output method allows for an increase in the accuracy of the classification of operation information of devices.

### Technology 2-6

An information output method including:
using operation information of a device on a simple operation set using a function or mode preset for the device so as to select a service for all users;
using operation information of the device on a complex operation set while changing the function or mode preset for the device so as to select a service for a specific user; and
outputting at least one of information on the service for all the users and information on the service for the specific user.

According to this information output method, a service for users is selected based on the mode of the operation setting of the device. This allows a service of the device reflecting the user's intentions and preferences to be suggested to the user.

### Technology 2-7

The information output method according to Technology 2-6, including:
outputting the information on the service for all the users to a device used by all the users and outputting the information on the service for the specific user to a device used by the specific user.

This information output method allows for the outputting of information on a service to a proper device.

### Technology 2-8

The information output method according to Technology 2-6 or 2-7, including:
deriving a frequency at which a predetermined operation has been performed based on a plurality of pieces of operation information on the simple operation and selecting a service for all the users based on the frequency.

This information output method allows for the selection of a proper service for all users.

### Technology 2-9

An information processing device including:
an acquisition unit that acquires operation information of a device;
a linking unit that maps operation information on a simple operation set using a function or mode preset for the device to all users among the operation information of the device and that maps operation information on a complex operation set while changing the function or mode preset for the device to a specific user among the operation information of the device; and
an output unit that outputs at least one of the operation information mapped to all the users and the operation information mapped to the specific user.

According to this information processing device, operation information of a device is classified into information of all users or information of a specific user based on the mode of the operation setting of the device. This allows the operation information that includes the user's clear intentions or preferences to be separated from the operation information that does not include the user's clear intentions or preference. Further, operation information output from this information processing device can be used to provide a service of a device that reflects the intentions and preferences of the users.

### Technology 2-10

An information processing device, including:
a selection unit that uses operation information of a device on a simple operation set using a function or mode preset for the device so as to select a service for all users and that uses operation information of the device on a complex operation set while changing the function or mode preset for the device so as to select a service for a specific user; and
an output unit that outputs at least one of information on the service for all the users and information on the service for the specific user.

According to this information processing device, a service for users is selected based on the mode of the operation setting of the device. This allows a service of the device reflecting the user's intentions and preferences to be suggested to the user.

### Technology 2-11

A computer program including computer-implemented modules including:
a module that acquires operation information of a device;
a module that maps operation information on a simple operation set using a function or mode preset for the device to all users among the operation information of the device;
a module that maps operation information on a complex operation set while changing the function or mode preset for the device to a specific user among the operation information of the device; and
a module that outputs at least one of the operation information mapped to all the users and the operation information mapped to the specific user.

According to this computer program, operation information of a device is classified into information of all users or information of a specific user based on the mode of the operation setting of the device. This allows the operation information that includes the user's clear intentions or preferences to be separated from the operation information that does not include the user's clear intentions or preference. Further, operation information output by this computer program can be used to provide a service of a device that reflects the intentions and preferences of the users.

### Technology 2-12

A computer program including computer-implemented modules including:
a module that uses operation information of a device on a simple operation set using a function or mode preset for the device so as to select a service for all users;
a module that uses operation information of the device on a complex operation set while changing the function or mode preset for the device so as to select a service for a specific user; and
a module that outputs at least one of information on the service for all the users and information on the service for the specific user.

According to this computer program, a service for users is selected based on the mode of the operation setting of the device. This allows a service of the device reflecting the user's intentions and preferences to be suggested to the user.

While various embodiments have been described herein above, it is to be appreciated that various changes in form and detail may be made without departing from the spirit and scope of the invention(s) presently or hereafter claimed.

What is claimed is:

1. An information output method comprising:
acquiring operation information of a device installed in a space;
using information linking the operation information of the device with the space in which the device is provided so as to:
map operation information of a device installed in a shared space used by a plurality of users to the plurality of users; and
map operation information of a device installed in a specific space used by a specific user to the specific user; and
outputting at least one of the operation information mapped to the plurality of users and the operation information mapped to the specific user.

2. The information output method according to claim 1, comprising:
based on spatial information indicating the function or type of a preset space, estimating whether the category of the space in which the device is installed is the shared space or the specific space; and
based on the estimated category of the space, identifying whether the operation information of the device is the operation information of the device installed in the shared space or the operation information of the device installed in the specific space.

3. The information output method according to claim 1, comprising:
even in the case of the operation information of the device installed in the specific space, mapping the operation information of the device to the plurality of users if a predetermined setting has been applied to the device.

4. The information output method according to claim 1, comprising:
even in the case of operation information of a device installed in a space used by the plurality of users, being able to map the operation information of the device to a specific user if a predetermined attribute is included in attributes of the plurality of users.

5. The information output method according to claim 1, comprising:
mapping operation information of a device whose installation space is not specified to the plurality of users.

6. An information output method comprising:
using operation information of a device installed in a shared space used by a plurality of users so as to select a service for the plurality of users;
using operation information of a device installed in a specific space used by a specific user so as to select a service for the specific user; and
outputting at least one of information on the service for the plurality of users and information on the service for the specific user.

7. The information output method according to claim 6, comprising:
outputting the information on the service for the plurality of users to a device used by the plurality of users and outputting the information on the service for the specific user to a device used by the specific user.

8. The information output method according to claim 6, comprising:
deriving a frequency at which a predetermined operation has been performed based on a plurality of pieces of operation information of a device installed in a space used by the plurality of users and selecting a service for the plurality of users based on the frequency.

9. An information processing device comprising:
an acquisition unit that acquires operation information of a device installed in a space;
a linking unit that uses information linking the operation information of the device with the space in which the device is provided so as to:
map operation information of a device installed in a shared space used by a plurality of users to the plurality of users; and
map operation information of a device installed in a specific space used by a specific user to the specific user; and
an output unit that outputs at least one of the operation information mapped to the plurality of users and the operation information mapped to the specific user.

10. An information processing device comprising:
a selection unit that uses operation information of a device installed in a shared space used by a plurality of users so as to select a service for the plurality of users, and
that uses operation information of a device installed in a specific space used by a specific user so as to select a service for the specific user; and
an output unit that outputs at least one of information on the service for the plurality of users and information on the service for the specific user.

11. A non-transitory recording medium having embodied thereon a computer program comprising computer-implemented modules including:
a module that acquires operation information of a device installed in a space;
a module that uses information linking the operation information of the device with the space in which the device is provided so as to:
map operation information of a device installed in a shared space used by a plurality of users to the plurality of users; and
map operation information of a device installed in a specific space used by a specific user to the specific user; and
a module that outputs at least one of the operation information mapped to the plurality of users and the operation information mapped to the specific user.

12. A non-transitory recording medium having embodied thereon a computer program comprising computer-implemented modules including:
a module that uses operation information of a device installed in a shared space used by a plurality of users so as to select a service for the plurality of users;
a module that uses operation information of a device installed in a specific space used by a specific user so as to select a service for the specific user; and
a module that outputs at least one of information on the service for the plurality of users and information on the service for the specific user.
